(19) United States
(12) Patent Application Publication
(10) Pub. No.: US 2020/0250349 A1
(43) Pub. Date: Aug. 6, 2020

(54) SECURITY SYSTEMS INCORPORATING CIRCUITRY CONNECTABLE TO THE INTERNET OF THINGS

(71) Applicant: SMARTPAK TECHNOLOGY LLC, Great Neck, NY (US)

(72) Inventors: Jordan S. Fersel, West Orange, NJ (US); Mark S. Rubin, Jamaica Estates, NY (US); Vivek Sharma, Morris Plains, NJ (US)

(21) Appl. No.: 16/641,794

(22) PCT Filed: Aug. 24, 2018
(86) PCT No.: PCT/US18/47905

§ 371 Date: Feb. 25, 2020

Related U.S. Application Data
(60) Provisional application No. 62/550,213, filed on Aug. 25, 2017.

(51) Int. Cl. G06F 21/86; H04L 29/08; G06K 19/077

(52) U.S. Cl. CPC G06F 21/86; G06K 19/07745; H04L 67/12

(57) ABSTRACT

The present disclosure includes, among other things, a printed circuit, wherein the circuit is adapted to send a signal to a wireless network when the circuit is open and/or closed, the circuit comprising a resealable seam where the circuit can be opened and closed and a processor configured to send a signal over a wireless network when the circuit is open and/or closed. The printed circuit may have a flexible adhesive backing. The circuit may also be attached to the interior or exterior of a container, where the circuit is open and thus sends a signal when the container is open.

### CROSS-REFERENCE TO RELATED APPLICATIONS

The present application is a national stage entry of International Application No. PCT/US2018/047905, filed on Aug. 24, 2018 which claims priority to U.S. Provisional Patent Application No. 62/550,213, filed on Aug. 25, 2017, which is hereby incorporated by reference herein in its entirety.

### FIELD OF THE TECHNOLOGY

The present disclosure relates generally to security devices and systems, and more particularly, to security devices and systems connectable to the Internet of Things.

### BACKGROUND

The security and control of valuable objects has been a constant goal throughout the history of mankind. The earliest known locking devices were discovered in the ruins of Nineveh, a city in the ancient country of Assyria. Later locking devices incorporating metal appeared in the 9^{th} century and have been attributed to the work of English craftsmen. Keys first appeared in antiquity as well, and an affluent Roman citizen often kept his valuable objects in a locked box at his home while carrying the key to the box on a finger ring.

Lock and key devices naturally improved in complexity and security during the Industrial Revolution. Security devices designed to set off an alarm upon unauthorized entry were developed. Moreover, as electronics technology has evolved in the 20^{th} century, security devices employing electronic technology has also evolved. For example, keycard locks are commonly used at hotels for individuals to control access to their rooms.

With technology advancing, it would be useful to have new security devices that incorporate the latest technology to ensure security of valuable objects.

### SUMMARY

In some embodiments, described herein are security devices, and parts for making such security devices, that incorporate circuitry that is connectable to wireless communication networks, such as the Internet.

Accordingly, in a first aspect, described herein a printed circuit with a flexible adhesive backing. The circuit is adapted to send a signal to a wireless network when the circuit is open, and the circuit includes a resealable seam where the circuit can be opened and closed. The circuit also includes a processor configured to send a signal over a wireless network when the circuit is open.

The circuit may have been printed onto a flexible material. The circuit may be on a flexible adhesive backing and the adhesive backing may be adherable to a container such that each surface of the container is covered with the printed circuit when the adhesive backing is adhered to the container. Such a container, having at least one surface (interior or exterior) covered with a printed circuit, is referred to as a security device. Alternatively, the printed circuit may have been three-dimensionally printed onto a surface of a container to form a security device. Alternatively, the printed circuit may be embedded into at least one surface of a container to create a security device. Any of these security devices may be adapted to hold at least one desirable object.

In some embodiments, the circuit stores a credential for authorized access. The processor may be configured to send a signal indicating an authorized access when the processor receives a signal with a credential that matches the credential stored in the circuit, and detects the circuit opening at the resealable seam. The circuit may be configured to receive the signal with a credential via near field communication (NFC). In many embodiments, the processor may be configured to send a signal indicating an unauthorized access when the processor detects the circuit opening without receipt of a signal with a credential that matches the credential stored in the circuit.

In various embodiments, the circuit is printed on sodium acetate.

In various embodiments, the present disclosure provides a circuitry container comprising a surface with an opening. The surface with the opening is partially or wholly covered with a circuit adapted to send a signal to a wireless network when the circuit is open. Accordingly, in an aspect of the present disclosure, the circuit includes a resealable seam that opens along the opening of the surface of the container. The circuit can be opened and closed when the opening of the surface is opened and closed. The circuit also includes a processor configured to send a signal over a wireless network when the circuit is open.

The circuit may be printed on a flexible surface. The printed circuit may have an adhesive backing. In some embodiments, the adhesive backing of the printed circuit may be adhered to the interior or exterior surface of the circuitry container.

In some embodiments, the printed circuit is printed on a sheet that is sandwiched between two adhesive layers, or between two layers of material used on a container surface.

Note that in the some embodiments, the circuit may be three-dimensionally printed onto a surface (interior or exterior) of a container to form a circuitry container.

The security device may be adapted to hold at least one desirable object.

In another aspect, the present disclosure provides a security container that comprises a circuit connectable to the internet of things, but also includes additional components including, without limitation, a photo camera, a video camera, a global positioning system, a geo-locator, a locking mechanism, a thermometer, and a hygrometer.

In further embodiments, the present disclosure provides a system for protecting a desirable object. Accordingly, in an aspect of the present disclosure, the system includes a security device including a surface with an opening. The surface with the opening is partially or wholly covered or partially or wholly lined with a circuit adapted to send a signal to a wireless network when the circuit is open. The circuit includes a resealable seam that opens along the opening of the surface (exterior or interior) of the container. The circuit can be opened and closed when the opening of the surface is opened and closed. The security device also includes a processor configured to send a signal over a wireless network when the circuit is open. The system further includes a computing device with a receiver for receiving the signal.

The computing device may store information from the signal. The information may include at least one of a date and time of an access of the container, and an authorized or unauthorized status of the access. The information may further include an identity of the user making the access.

The computing device may include a processor that executes an application that stores information from the signal. The computing device may include a processor that executes an application configured to transmit a signal with a credential to the container for storage in the circuit. The computing device may be configured to store a credential. The computing device may be configured send a signal with a credential using near field communication (NFC), or another form of wireless communication. In some embodiments, the container is three-dimensionally printed.

### BRIEF DESCRIPTION OF THE DRAWINGS

The foregoing features of embodiments will be more readily understood by reference to the following detailed description, taken with reference to the accompanying drawings of the following figures.

FIG. 1 is a diagram depicting an exemplary security system for notifying a user of accesses to a security device equipped with circuit-based security;

FIG. 2 is a schematic diagram depicting an exemplary printed circuit that can be folded into a parallelepiped-shaped container, or can be adhered or embedded into a surface of a parallelepiped-shaped container;

FIG. 3 is a schematic diagram of an exemplary printed circuit showing at least one resealable seam. In the circuit depicted in FIG. 3, there are two breaks in the conductive trace of the circuit along where the resealable seam opens and closes. The circuit may be printed on flexible material, and may have an adherable back and/or front surface);

FIG. 4 is a schematic diagram depicting an exemplary printed circuit that may be adhered or embedded into a surface of a cylinder-shaped container having a circumference of 5.00 inches or less. Note that in the non-limiting circuit shown in FIG. 4, the bottom lid of the cylinder is not covered or embedded with the printed circuit.

FIG. 5A shows a three-dimensional perspective view of an exemplary security device having the form factor of a cylindrical container;

FIG. 5B is a side view of the security device of FIG. 5A;

FIG. 5C is a sectional view of the security device of FIG. 5A, where the section is taken along the plane depicted as A in FIG. 5B;

FIG. 5D is a top view of the security device of FIG. 5A;

FIG. 6 is a block diagram illustrating an exemplary security system including a security device and designated computing system. The block diagram shows functional representations of the sensing circuit of the exemplary security system;

FIG. 7 is a schematic illustrating an exemplary sensing circuit of a security device;

FIG. 8 is a perspective view illustrating an exemplary security device having the form factor of a parallelepiped-shaped container;

FIG. 9A is a diagram illustrating an exemplary circuit for a security device;

FIG. 9B is a diagram illustrating the exemplary circuit integrated with a security device having the form factor of an envelope;

FIG. 10A is a diagram illustrating an exemplary circuit in an envelope-shaped security device;

FIG. 10B is a diagram illustrating the opened envelope-shaped security device of FIG. 10A; and

FIG. 11 is a schematic diagram depicting an exemplary printed circuit, for a security device, having two adhesive surfaces, much like double sided tape, in a non-limiting embodiment.

### DETAILED DESCRIPTION

Most of the developed world and increasing parts of the developing world are now connected via some wireless means to the Internet. In some embodiments, the present disclosure provides security devices, and parts thereof, that employ sensing circuitry to connect to the Internet.

The published patents, patent applications, websites, company names, and scientific literature referred to herein establish the knowledge that is available to those with skill in the art and are hereby incorporated by reference in their entirety to the same extent as if each was specifically and individually indicated to be incorporated by reference. Any conflict between any reference cited herein and the specific teachings of this specification shall be resolved in favor of the latter.

The further aspects, advantages, and embodiments of the present disclosure are described in more detail below. The definitions used in this specification and the accompanying claims shall following terms shall have the meanings indicated, unless the context clearly otherwise requires. Any conflict between an art-understood definition of a word or phrase and a definition of the word or phrase as specifically taught in this specification shall be resolved in favor of the latter. As used in this specification, the singular forms “a,” “an” and “the” specifically also encompass the plural forms of the terms to which they refer, unless the content clearly dictates otherwise. The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 20%.

The security and control of desirable objects remains a goal of present times. Indeed, as desirable objects have become smaller and easier to conceal (e.g., a microchip carrying confidential information), the security of such objects remains an important and difficult to achieve goal. As used herein, a “desirable object” is meant to be an object that is valuable or is of interest to an individual, group, company, or institution. Desirable objects can include, without limitation, consumable objects (e.g., smokable or edible marijuana, addictive drugs such as opioid drugs, FDA approved drugs, or candy), objects of high monetary value (e.g., currency or bearer bonds), objects containing important electronic information (e.g., a disc or USB Flash drive containing software code, emails, trade secret formulas, customer lists, etc.), hazardous objects, objects that convey valuable information (e.g., papers containing bank account numbers and credentials, birth certificates, Social Security numbers), ballots (either blank or filled in), precious metals or gems, and objects with evidentiary significance (e.g., objects present at a crime scene).

In some embodiments, the individual to whom the desirable object is desirable is a human (e.g., an adult or a child). In some embodiments, the individual is an animal. For example, if the individual is a chimpanzee, the desirable object may be, for example, a consumable object such as an orange.

Attempts have been made to prevent tampering of sealed packages. For example, Petersen and Wilson, U.S. Pat. No. 7,119,684 describes closure tabs containing coatings or electronically conducting glue that can store data in its memory. Ehrensvärd et al., U.S. Pat. No. 7,170,409 and Ehrensvärd et al., U.S. Pat. No. 7,772,974 describe electronic modules and seals on packaging that stores information in its memory. Lyon et al., U.S. Patent Publication No. 2006/0255953 describes a seal for package that comprises a circuit that can reveal if the package has been tampered with. Wilson et al., U.S. Patent Publication No. 2013/0285681 describes a smart package with electronic sensor monitoring. All of these patent publications are hereby incorporated by reference in their entireties.

However, the prior art packages cannot be resealed.

Accordingly, provided herein is a printed circuit, where the printed circuit is connectable to the Internet and where the circuit is resealable. In some embodiments, the printed circuit is wirelessly connectable or connected to the Internet.

As networks supporting Internet access proliferate and become more ubiquitous (e.g., Wi-Fi, 4G), configuring devices with the capacity to communicate with other devices through these networks enables an unprecedented level of connectivity. A user often designates at least one computing device, such as a smartphone, laptop computer, or smart watch, to connect with other receiving devices (e.g., thermostat, automobile, home security system). The designated computing device may control the receiving devices, as well as obtain, process, and/or store data about them. This environment of connected devices, sometimes known colloquially as the “Internet of Things” or “IoT”, is unleashing previously unimagined capabilities for users.

As used herein, by “wireless” is simply meant a connection that does not require physical wires to connect to a wireless network. By “wireless communication network” is a network with nodes that communicate using wireless connections. In some embodiments, the wireless communication network is connected to the Internet. Exemplary wireless communication networks may be based, for example, on Bluetooth, the IEEE 802.11 WLAN standard (i.e., “Wi-Fi”), the IEEE 802.16 standard, 3G technology, 4G technology, or next generation technologies.

By “computing device” is meant an electronic device that can directly (via a wireless or wired connection) access the Internet. Non-limiting computing devices include server systems, computers (including laptop or desktop computers), tablets (e.g., iPad® tablets from Apple, Inc. and Fire® tablets from Amazon, Inc.) and smartphones, such as an iPhone® (Apple, Inc.) or Galaxy® smartphones (Samsung Electronics Co., Ltd.).

By “receiving device” is meant an electronic device that can connect (via a wireless or wired connection) to a computing device. The circuit described herein, as well as the security devices described herein, are non-limiting receiving devices. The receiving device can connect to the computing device by various methods as are commonly known. The receiving and computing devices may include transmitters, receivers, or transceivers for transmitting and/or receiving communication signals. In some embodiments, the receiving device may include a processor coupled to a communications circuit such as a transceiver for transmitting and receiving signals, and processes signals received (and/or to be transmitted) by the transceiver.

As used herein, by the term “container” means any type of container that has an internal surface and an external surface, and that can contain an object. Containers can be of any size or shape. Containers include, without limitation, cylindrical containers (e.g., pill bottles), flat containers (e.g., envelopes), spherical containers (e.g., a basketball-shaped cookie jar), and so forth. It should be noted that container need not be completely closed. For example, a band encircling a desirable object (e.g., a paper wrapper encircling a stack of $100 bills) is considered a container as the term is used herein.

As the term is used herein, a “security device” is meant a container having at least one surface, where a portion of at least one surface is either covered by a sensing circuit or has a sensing circuit embedded in it, where the circuit is adapted to send a signal over a wireless communication network when the circuit is open. A security device comprising a sensing circuit, either on at least part of one of its surfaces or embedded into at least part of at least one of its surfaces, may be referred to as “a security device incorporating circuitry . . . ”. In some embodiments, the at least one portion of the surface in the security device that is covered by or embedded with the sensing circuit in located over the site in the security device where the security device is typically opened. For example, if the security device is an envelope, the sensing circuit may, in some embodiments, span the envelope flap. Alternatively, the sensing circuit, if printed on a flexible substrate, may be positioned over the edge of an envelope, so that its seal is broken or opened when the envelope is opened with, for example, a letter opener or scissors.

Note that as used here, the term “sensing circuit” is simply a contiguous conductive trace with an electronics module serving as a processor printed onto a material (e.g., a flexible and/or adhesive material). Because the electronics module can detect when the contiguous conductive trace is opened (e.g., along the a resealable seam), this circuit is a sensing circuit. The electronics module can also detect when the conductive trace is closed (e.g., the resealable seam is re-sealed).

In some embodiments, the sensing circuit is adapted to send a signal to a wireless communication network when the sensing circuit is open. In some embodiments, the sensing circuit includes at least one resealable seam where the sensing circuit can be opened and closed. The circuit also includes a processor coupled to communication circuitry (e.g., a communications circuit) configured to send a signal over a wireless communication network when the sensing circuit is open. This signal can be sent in real time of the opening of the circuit. In other words, the signal is not stored on the circuit but is rather transmitted over a wireless communication network, such as the Internet, at the same time as or very shortly after the circuit is opened. In some embodiments, the signal that the sensing circuit is opened is transmitted in less than ten minutes, or in less than five minutes, or in less than one minute, or in less than 30 seconds, or in less than 5 seconds after the sensing circuit is opened.

Although not wishing to be bound by any theory, in some embodiments, the processor may send a continuous signal over a wireless communication network when the sensing circuit is closed. Then the sensing circuit is opened (e.g., by being opened along the resealable seam or broken open elsewhere), the continuous signal may stop, thereby signaling to the wireless communication network that the sensing circuit is open. If the sensing circuit had been opened along the resealable seam and is then closed along that same seam, the continuous signal from the processor would resume, thereby signaling to the wireless communication network that the sensing circuit is closed again.

In some embodiments, security devices such as the devices described herein are connectable to the Internet of Things to protect desirable objects.

System Embodiments

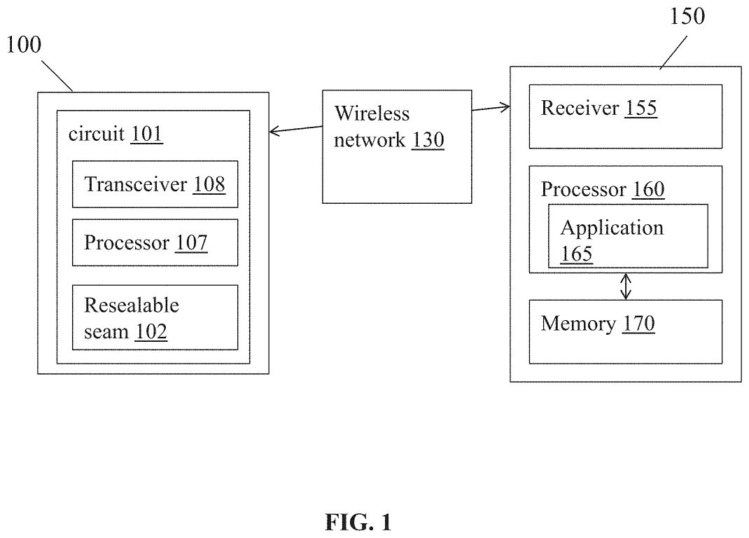

Disclosed herein are embodiments of a robust and inexpensive solution for monitoring access to desirable objects within the environment of the Internet of Things. As depicted in FIG. 1, a user may store a desirable object in a container that is equipped with the sensing circuit 101 of this disclosure. The container with the circuit described herein is referred to a security device 100, which is a non-limiting type of receiving device. The sensing circuit 101 may include a processor 107 coupled to communication circuitry (e.g., a communication circuit) such as a transceiver 108. The sensing circuit 101 may include at least one resealable seam 102. Each time the sensing circuit 101 detects that the contents of the security device 100 have been accessed (e.g., detects that the resealable seam 102 has been opened), the processor 107 communicates, via the transceiver 108, over a wireless communication network 130 with a designated computing device 150 regarding the access. In this manner, the owner or authorized user of the designated computing device 150 may receive notifications whenever a user attempts to access the desirable object in the security device 100 in either an authorized or unauthorized manner. Further, the designated computing device 150 may include a receiver 155 (or, in other embodiments, a transceiver) for receiving the signal from the security device 100. A processor 160 on the designated computing device 150 may execute an application 165 that stores information about each access (e.g., date, time, identity of accessor, authorization for access) in memory 170. The processor 160 may also execute an application 165 that stores information about the temperature, humidity, and geo location of the security device 100 in memory 170.

The sensing circuit 101 determines that the contents of the security device 100 have been accessed when the sensing circuit 101 is in an open state. For example, the sensing circuit 101 may include a resealable seam 102 by which the sensing circuit 101 may be opened or closed, and the resealable seam 102 may be aligned with an opening of the security device 100 or container. In this manner, when a user opens the security device 100, the user simultaneously opens the resealable seam 102 and, consequently, opens the sensing circuit 101. When the user closes the security device 100, and thereby reseals the resealable seam 102, the sensing circuit 101 is likewise closed again.

The opening of the sensing circuit 101 disrupts the flow of current in the circuit. This disruption in current flow can be detected by the processor coupled to the circuit having the resealable seam. Similarly, the processor is able to detect the continuous flow of current once the resealable seam has been closed. Instead of, or in addition to, the processor may measure voltage or other electrical property of the circuit to determine whether the sensing circuit 101 is open or closed.

Note that the printed circuits described herein, in some embodiments, may be manufactured as a security device. For example, the sensing circuit 101 (See FIG. 1) may be printed in three dimensions onto the surface of a security device 100 of any form factor (e.g., boxes, cylindrical tubes, etc.), and the printed circuit may have one or more resealable seams 102 positioned at the openings of the security device 100. Alternatively, the sensing circuit 101 may be three-dimensionally printed into the shape of a container to form the security device 100. In any of these embodiments, the sensing circuit 101 may be printed using metallic or conductive inks to form the conductive trace. Such inks are well known in the art and are commercially available (e.g., from Methode Electronics, Inc. Chicago, Ill., and TEKRA, A Division of EIS, Inc., New Berlin, Wis.).

In some embodiments, the circuit described herein can be printed onto a flexible material. In embodiments where the circuit is both flexible and adhesive, the circuit may be printed directly onto a flexible adhesive backing, or may be printed onto a flexible material, and a second layer of a flexible adhesive backing attached to a portion of one surface of the printed circuit. In some embodiments, the adhesive backing may be adherable to a portion of the container surface (either the internal surface or the external surface) to create a security device. In some embodiments, at least a portion of both surfaces (e.g., front and back) of the printed circuit are adhesive.

In some embodiments, the printed circuit comprises a flexible adhesive backing on one of its two surfaces. In some embodiments, the printed circuit comprises two surfaces, a portion of each of which is covered with an adhesive material.

In some embodiments, at least a portion of a surface of a container is covered with the printed circuit when the adhesive backing is adhered to the container to make a security device. Alternatively, the printed circuit may have been three-dimensionally printed onto a surface of a container to make a security device. Any of these security devices may be adapted to hold at least one desirable object.

Exemplary Security Devices

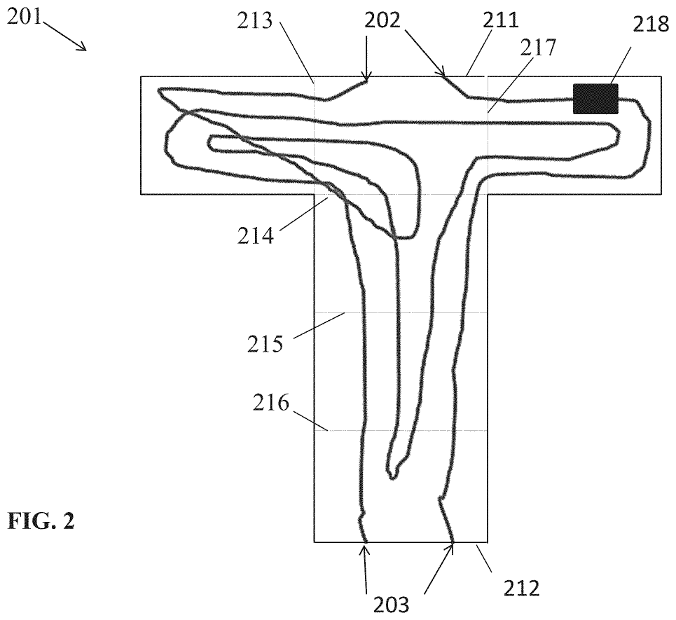

FIG. 2 depicts a schematic diagram of an exemplary embodiment of a sensing circuit 201 that is printed onto a flexible material. The sensing circuit 201 may be configured into a box-shaped three-dimensional security device or to convert a box into a three-dimensional security device. The sensing circuit 201 includes discrete rectangular portions connected by edges 211, 212, 213, 214, 215, 216, and 217 (collectively, 212-217). Note that when the term “flexible material” is used, the entire material need not be flexible. In the diagram shown in FIG. 2, for example, the material may only be flexible where the printed circuit is folded to form a cube-shaped box (e.g., the material may be flexible only on edges 213, 217, 214, 215, and 216). Note that edges 211 and 212 are the edges that open the circuit along resealable seams 202 and 203. For example, when a user folds the sensing circuit 201 along edges 213-217, the user may overlay the rectangular portions over the surfaces of a box so that the box becomes a three-dimensional security device. Throughout most of the rectangular portions, the conductive trace of the sensing circuit 201 is configured to be continuous. However, it is also configured to cross the edges 211, 212 of two, non-adjacent portions. Thus, when the sensing circuit 201 is arranged over a cube-shaped box, portions of the sensing circuit 201 connect across these two edges 211, 212 and the circuit closes. In particular, the rectangular portion with edges 212 and 216 may be positioned over the lid of the box. When the lid is closed, the edges 211, 212 maintain contact, and the sensing circuit 201 is closed at resealable seams 202 and 203. When a user opens the lid of the box, contact breaks along the resealable seams 202 and 203 and the sensing circuit 201 opens. Electronics module 218 is coupled to the conductive trace of the sensing circuit 201 to drive the conductive trace, sense any intrusion into the security device, and transmit a signal to a designated computing device. In some embodiments, the conductive trace is configured to be reusable each time the lid is closed. In some embodiments, at resealable seams 202 and 203, the conductive trace is configured to separate to interrupt current flow and reseal for current to continue to flow, thus creating a reusable and resealable sensing circuit.

It should be noted that the circuit can be attached to the interior or exterior of a container to create a security device. When the circuit is on the interior of the security device, in some embodiments, the circuit is not visible from the exterior of the device. Thus, in one embodiment, an ordinary-looking envelope may in fact be a security device, and an unauthorized person breaking the seal of the envelope may unknowingly break (or open) the circuit) and therefore notify the owner or authorized user.

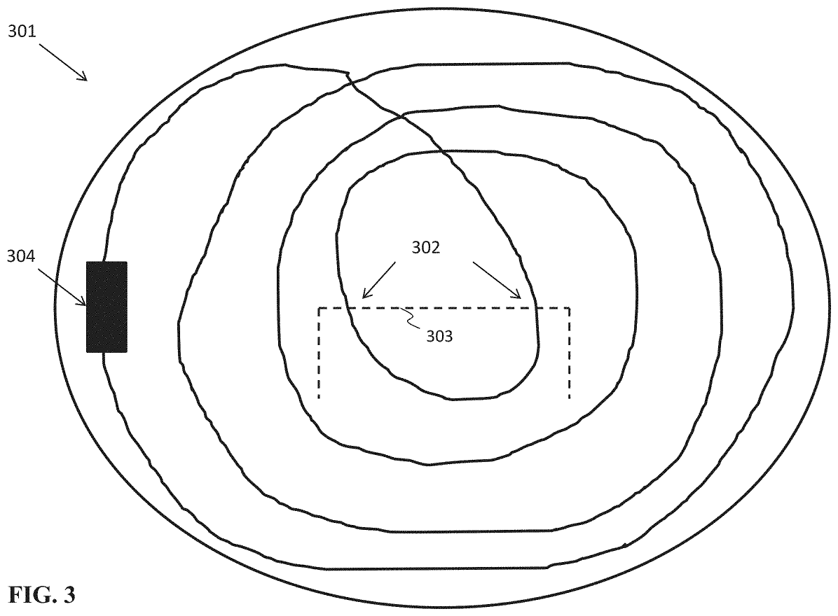

In another example, FIG. 3 depicts a schematic diagram of an exemplary embodiment of a printed sensing circuit 301 that can be printed onto a material that includes a perforated opening 303 that crosses two resealable seams 302 of the conductive traces of the sensing circuit 301. When the perforated opening 303 is opened, the conductive traces of sensing circuit 301 will break along the resealable seams 302. The sensing circuit 301 can be adhered to a flat surface of a container having an opening along the perforation, thereby creating a security device. For example, the sensing circuit 301 may be adhered to a surface of an envelope or embedded into a surface of an envelope. Electronics module 304 is coupled to the conductive trace of the sensing circuit 301 to drive the conductive trace, sense any intrusion into the security device, and transmit a signal to a designated computing device via a communication circuit over a wireless communication network (e.g., over the Internet).

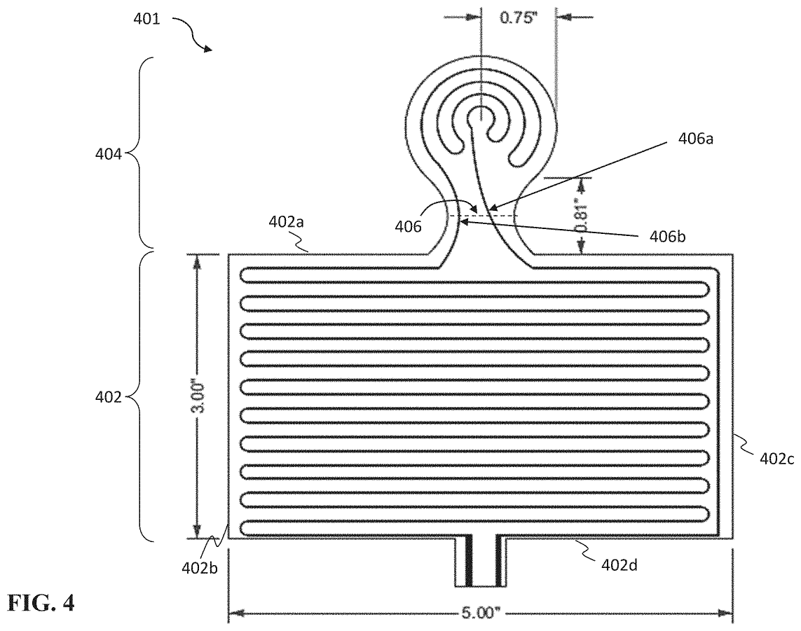

FIG. 4 illustrates an exemplary embodiment of a sensing circuit 401, which is flexible and printed, that can be configured in a three-dimensional shape by wrapping the circuit to form a cylindrical container with a lid to form a cylindrical security device. The sensing circuit 401 includes a rectangular portion 402 with a top 402a, left 402b, right 402c, and bottom 402d edges. The sensing circuit 401 also includes a circular tab portion 404 positioned along the top edge 402a of the rectangular portion 402. The left 402b and right 402c edges may be adhered together to form a cylindrical body, and the circular tab 404 may be folded over to form a lid of the circuitry container. A second circular tab (not shown in FIG. 4) positioned along the bottom edge 402d may be folded over to form the bottom of the security device. A resealable seam 406 may be formed between the circumference of the circular tab 404 and the top edge 402a of the rectangular portion 402 of the sensing circuit 401. The sensing circuit 401 is designed to cover a cylindrical pill container or be embedded into a cylindrical pill container, where the lid of the cylindrical pill container can be either popped off or screwed off. The exemplary dimensions of the sensing circuit 401, corresponding to a typical cylindrical pill container, have a circular portion 404 with an approximate 0.75 inch radius and a cylindrical portion with unfurled rectangular dimensions of approximately 3 inches by 5 inches, the circular and cylindrical portions separated by an approximate length of 0.81 inches. When the lid is closed, the circular tab 404 and top edge 402a maintain contact at resealable seam 406 and the sensing circuit 401 is closed. When the lid of the cylindrical security device 400 is opened, circuit traces 406a and 406b break along the resealable seams 402 and the sensing circuit 401 opens.

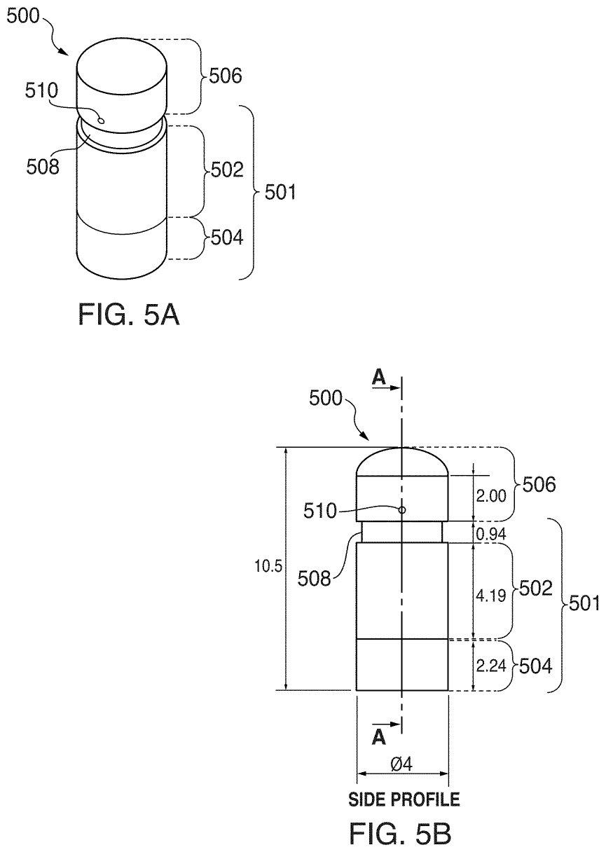

FIGS. 5A-5D illustrate an exemplary embodiment of a security device 500 having the form factor of a canister. FIG. 5A shows a three-dimensional view of the security device 500 including a body 501 having a top portion 502 and bottom portion 504. The body 501 of the security device 500 is covered by a lid 506 (or cap) at the neck 508 of the body 501. The lid 506 of security device 500 includes a sensor hole 510 positioned at a side of the lid 506. The sensor hole 510 is configured to detect the opening of the security device 500.

The body 501 of the security device 500 houses a sense film 528, which is in series with a magnetic lock switch (not shown). Furthermore, a magnet (not shown) is embedded in the lid 506. When the lid 506 of the security device 500 is closed, the magnet closes the magnetic lock switch to complete the circuit. Removal of the lid 506 decouples the magnet from the magnetic lock switch to break the circuit.

FIG. 5B illustrates a side view of the exemplary security device 500. For example, the length of the security device 500 can be approximately 10.5 inches long with a diameter of approximately 4 inches. The lid 506 has a cylindrical length of approximately 2 inches capped with a domed-shape with a height of approximately 1.13 inches. The body 501 of the security device is approximately 7.37 inches, which includes a bottom portion 504 of approximately 2.24 inches and a top portion 502 of approximately 4.19 inches. Note that the neck 508 of the body, which is allows the lid 506 to be positioned securely on the body of the security device 500 via a friction fit, by way of example.

FIG. 5C illustrates a sectional view of the exemplary security device 500, the section corresponding to the section line AA of FIG. 5B. Note that the body 501 of security device 500 is made up of interior and exterior walls defining an electronics compartment 512 and an item storage compartment 514. The exemplary diameter of the interior cylindrical volume is approximately 3 inches. The bottom portion 504 of the body 501 consists of a first exterior wall 516 fitted onto a first interior wall 518 of body 501. In some embodiments, the bottom portion 504 may be removed by, for example, unscrewing the bottom portion 504 from the body 501.

The top portion 502 consists of a second exterior wall 520 that includes a lip 522 to hold a panel 524 to separate the item storage compartment 514 and the electronics compartments 512. The body 501 further includes a second interior wall 526 adjacent to the second exterior wall 520 and panel 524. The second interior wall 526 also forms the neck 508 of the security device 500. Further included on the interior surface of the second interior wall 526 is sense film 528.

Note that the sense film is electrically coupled to the electronics module (described further herein below) in the electronics compartment. The cylindrical body is capped with lid 506 consisting primarily of a continuous wall. FIG. 5D illustrates a top view of the exemplary security device 500 having an approximate diameter of 4 inches. Note that the dimensions provided herein are for illustration purposes and the term “approximately” can be used to mean within an order of magnitude, within manufacturing tolerance, and/or within 5%, 10%, or 20% of the stated number.

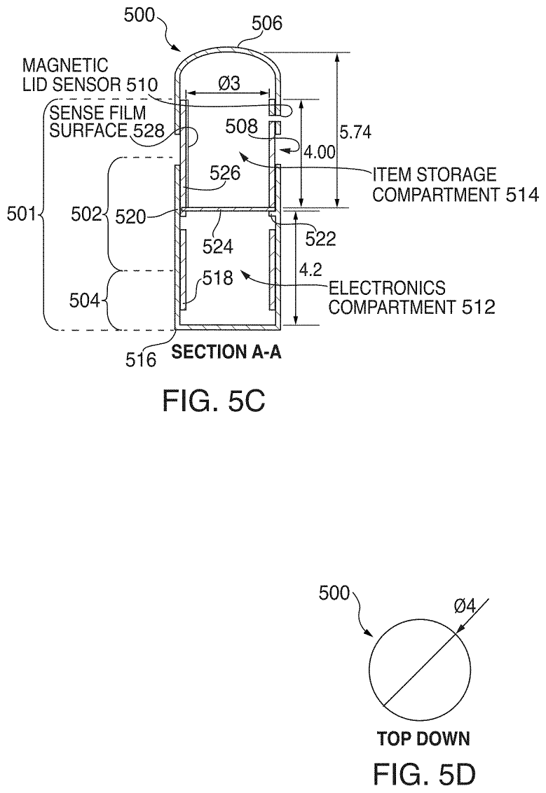

FIG. 6 is a diagrammatic representation of an exemplary embodiment of sensing system 600 of a security device. The sensing system 600 includes an embedded system 602 having a processor, such as a microcontroller 604, and a modem 606. The microcontroller 604 is coupled to the sensor monitor circuit 608 and sensors 610. The microcontroller 604 may have a memory module or may otherwise be coupled to a memory module. In some embodiments, sensors 610 can include thermal and humidity sensors that measure these conditions of the security device. Sensors 610 can be an optical, acoustic, electromagnetic, chemical, pressure, proximity, and/or mechanical sensor. Sensors 610 can also include a camera for a designated computing system 612 in communication with the security device, via the modem 606, to allow a person using the designated computing system 612 to see inside and/or outside of the security device. Sensors 610 can include a geolocation sensor to provide geolocation data, via the modem 606, to the designated computing system 612. A geolocation sensor can be a global positioning system (GPS), internet protocol (IP) address, and/or wireless communication network.

The sensor monitor circuit 608 includes a constant current driver 614 to provide a constant current to a sensor film 616 of the sensing elements 618. The sensor film 616 can be a printed circuit such as any of those illustrated in FIGS. 2-5. The sensor film 616 is coupled to a magnetic interlock switch 620. The sensing elements 618 provide a current and/or voltage input to a window comparator 622 configured to determine whether the current or voltage input is within a reference upper and lower current or voltage limits, respectively. Coupled to the window comparator 622 are an oscillator 624, which provides the frequency for sampling rate of the window comparator 622, and a digital window adjustment module 626, which is configured to adjust the upper and lower limits of the window comparator. In some embodiments, the adjustment module is a digital potentiometer, such as a 10 kΩ MCP4151 manufactured by Microchip Technology Inc., of Chandler, Ariz. Thus, the limits of the window comparator may range from 0 to 10 kΩ.

When the security device is opened, the magnetic interlock switch 620 opens to break the circuit, and the current and/or voltage output by the sensing elements 618 falls below the lower limit of the window comparator 622. In this manner, the microcontroller 604 may detect that the security device has been opened.

The data from the sensor monitor circuit can be processed by the embedded system 602 and transmitted to the designated computing system 612 over a wireless communication network 627 to the data interface 627. In some embodiments, the designated computing system 612 employs a geolocation service 628 to obtain the location of the security device 100. Thus, the designated computing system 612 may track the locations of all security devices 100 with which it communicates. In some embodiments, the geolocation service 628 operates using cell tower triangulation and/or global positioning systems. The data portal 630 may be a data monitoring service that monitors information, such as location, temperature, sensor status, etc., provided by the security devices 100. The designated computing system 612 may log this information over time. In some embodiments, the data portal 630 may trigger alarms or events based on thresholds applied to incoming data. In those situations, the data portal 630 may communicate with the messaging service 632 to send out SMS/text messages regarding events, such as opening of particular security devices 100.

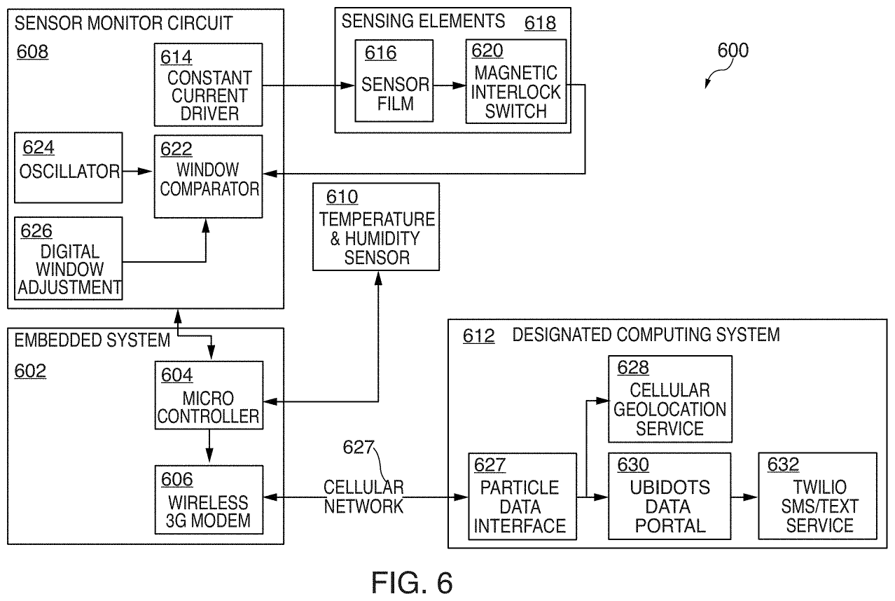

FIG. 7 illustrates a schematic of an exemplary embodiment of sensing circuit of a security device. The sensing circuit 700 includes a microcontroller interface header 702 which provides leads to connect (and disconnect) a microcontroller such as the microcontroller 604 shown in FIG. 6. In some embodiments, instead of a microcontroller interface header 702, a microcontroller 604 can be directly coupled to the rest of the sensing circuit 700. In some embodiments, the microcontroller 604 can be connected to sensor integrated circuit (IC) 704. This can be a temperature and/or humidity sensor. In some embodiments, the microcontroller 604 can be connected to various sensors such as sensor 610 described above.

The microcontroller can be connected to a tamper monitor circuit 706 and a tamper sensitivity adjustment circuit 708. The tamper monitor circuit 706 includes a timer IC 710 that provides the oscillator for the window comparator 712. The window comparator 712 takes inputs from two digital potentiometers 714 and 716 of the tamper sensitivity adjustment circuit 708. As described above, the tamper sensitivity adjustment circuit 708 allows the microcontroller to vary the upper and lower current or voltage limits on the window comparator 712. The tamper sensitivity adjustment circuit 708 is coupled to the constant current sensor driver circuit 718, which provides constant current to the sensing elements 720. The sensing elements 720 as described above include printed sensor film 722 and magnetic lock switch 724.

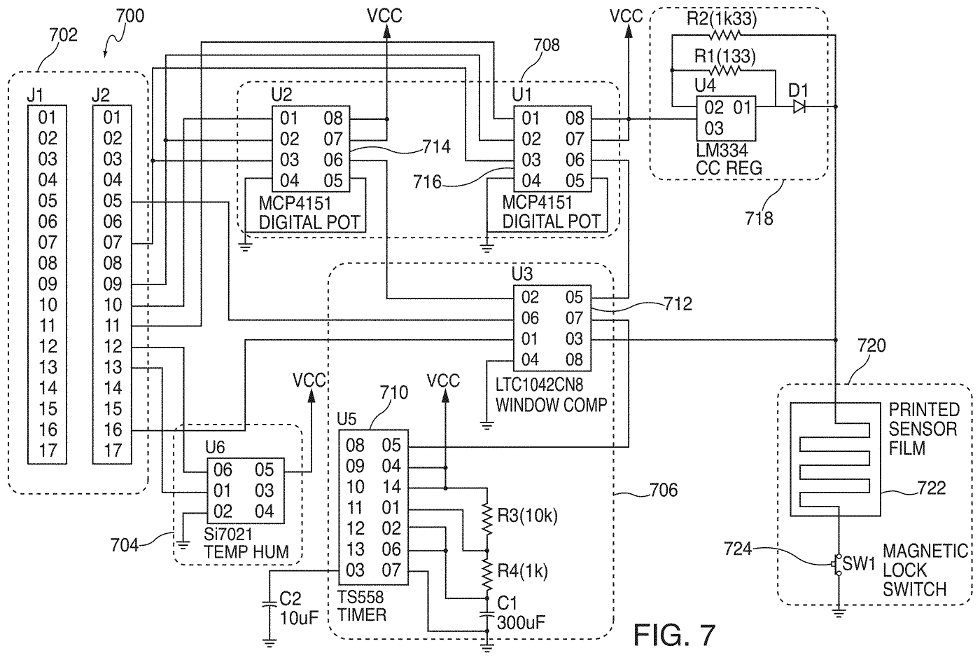

FIG. 8 illustrates a graphic representation of an exemplary embodiment of a security device. The security device 800 has a form factor of a rectangular box with a lid, forming a bottom portion 802 and a top portion 803. The bottom portion 802 is split primarily into two subsections, an electronics compartment 804 and an item storage compartment 806, by a barrier 808. The electronics compartment 804 includes at least an embedded microcontroller 810 (having a modem and a cellular antenna 811) coupled to a sensor monitoring circuit 812. The sensor monitoring circuit 812 is coupled to a film sensor 814 with two sections, 814a and 814b. The sections 814a, 814b are cut and formed to fit parts of the interior surfaces of the bottom portion 802 and the top portion 803. The film sensor 814 is primarily positioned around the item storage compartment 806. When the security device 800 is opened or tampered with such as to break the connection between the sections 814a and 814b of the film sensor 814, the sensor monitoring circuit 812 senses the change and communicates with the microcontroller 810 to send a message to a designated computing system (not shown). Note that the circuit described in FIGS. 6-7 can be used as part of security device 800.

Exemplary Processes for Forming Security Devices

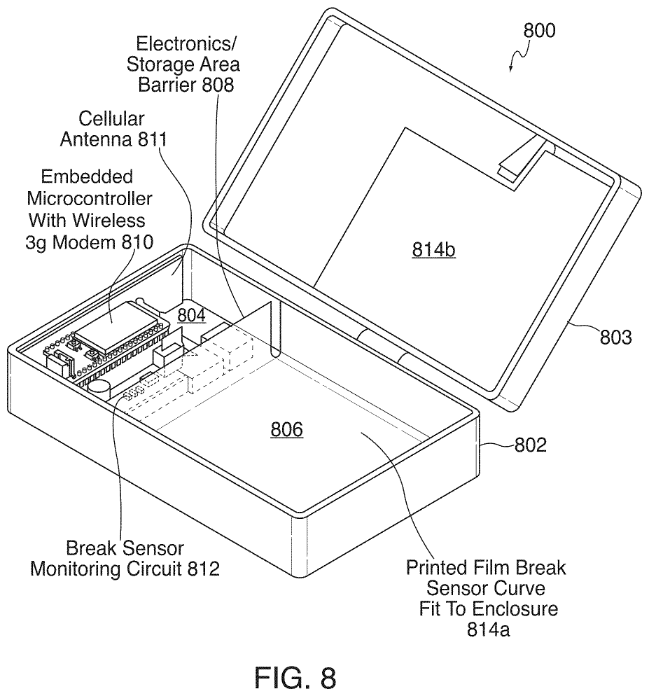

FIGS. 9A-9B are schematic diagrams depicting how an envelope can be made into a security device. FIG. 9A shows a sensing circuit 900 having an area smaller than the area of a side of a standard envelope. The sensing circuit 900 has an adhesive backing that allows the sensing circuit 900 to stick to a surface, such as the paper surface of an envelope. The sensing circuit 900 includes conductive trace 902 wound on a substrate 904. The conductive traces complete a closed circuit at the electronics module 906. The electronics module includes a sensor monitoring circuit 906 that determines a break in the conductive trace 902. FIG. 9B shows the printed circuit 900 adhered to the exterior of the envelope 908. More specifically, the printed circuit 900 is positioned over the opening of the envelope 908. Note that in FIG. 9B, there are multiple points (such as at points 910) along the conductive trace 902 that is configured to open (or break) when the envelope 908 is opened. Even opening a single one of the plurality of points can send a wireless communication signal to a designated computing system to notify an authorized user or owner that the envelope 908 has been opened.

Note that the example provided in FIGS. 9A-9B can include a resealable seam such that envelope 908 and sensing circuit 900 can be closed and reused more than once. The sensing circuit 900 may be visible to a recipient of the envelope or it may be covered in a material to camouflage or otherwise cover the sensing circuit 900 from visual inspection by the recipient. The recipient, in many cases, may not know that the envelope opening is sensed and communicated to an external party.

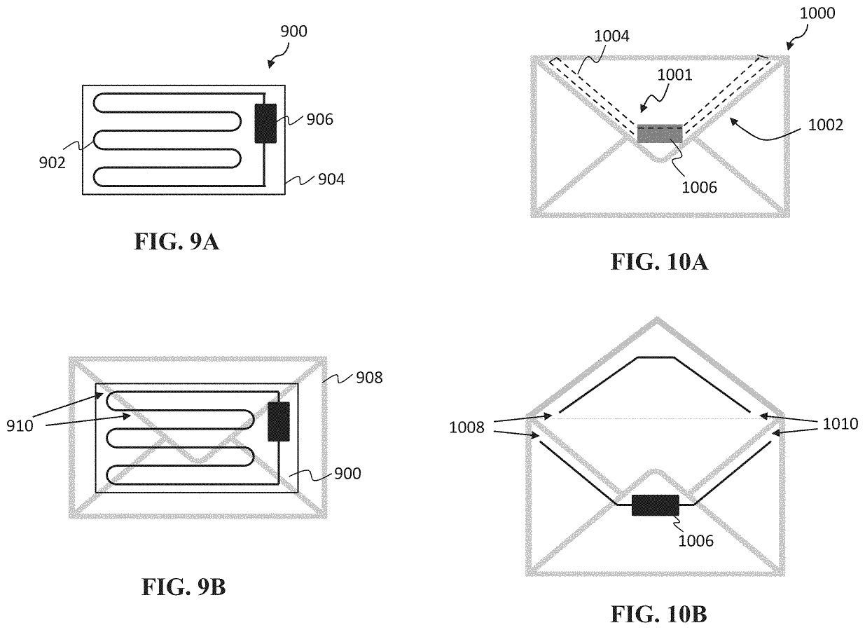

FIG. 10A illustrates a schematic diagram of an exemplary embodiment of a security device 1000 in the form factor of an envelope. A sensing circuit 1001 can be positioned under the opening 1002 of the envelope. The sensing circuit 1001 includes a conductive trace 1004 that forms a complete circuit with an electronics module 1006. The electronics module 1006 includes sensing and communications circuitry to sense and communicate the opening or breaking of the circuit. The conductive trace 1004 is printed or positioned along the outer edges of the envelope opening 1002 to form a loop. In FIG. 10B, when the envelope is opened, the loop formed by the conductive trace 1004 is broken at least at the positions 1008 and 1010.

In some embodiments, the sensing circuit 1001 stores a credential for authorized access. The processor in the security circuit may be configured to send a signal indicating an authorized access when the processor receives a signal with a credential that matches the credential stored in the circuit, and detects the circuit opening at a resealable seam. The security circuitry may be configured to receive the signal with a credential via near field communication (NFC). In many embodiments, the processor may be configured to send a signal indicating an unauthorized access when the processor detects the circuit opening without receipt of a signal with a credential that matches a credential stored in the circuit.

In various embodiments, the sensing circuit is printed or formed on a substrate comprising sodium acetate.

In some embodiments, the security circuit is printed on a substrate that is sandwiched between two adhesive layers, or between two layers of material to be used on a container surface. The surface may be, for example, the surface on a security container configured to be opened. In some embodiments, the sandwiched circuit is hidden from the outside of the container, hidden from the inside of the container, or both. In some embodiments, sandwiching the circuit between layers (e.g., of material or of adhesive layering) protects the circuit from damage, for example, by either the contents inside of the container, from damage by contact of the container exterior to the container, or both. For example, if the container is an envelope that is accidentally slammed by the door of a mail box, the layer over the printed circuit on the exterior surface of the envelope may protect the printed circuit from damage or from being opened and thus sending a signal to the authorized user or owner.

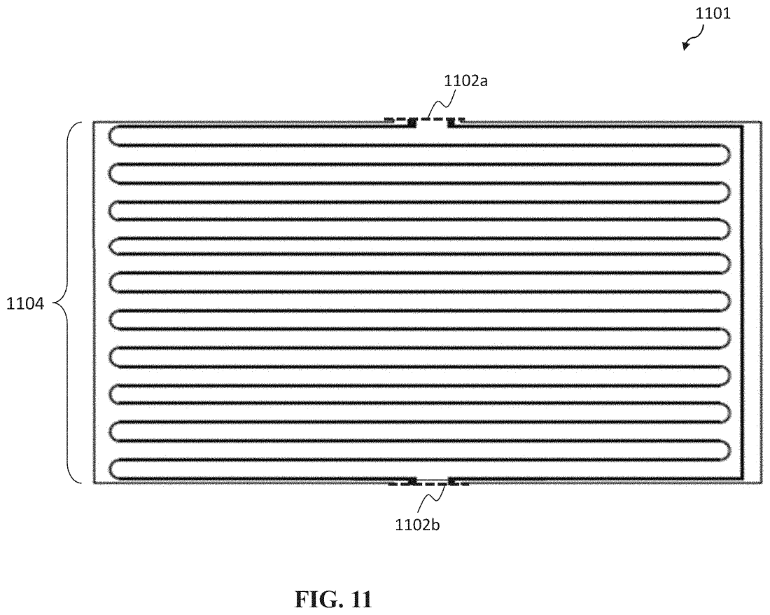

For example, in the embodiment in which the circuit for a security device is sandwiched between two adhesive layers, the circuit acts much like a piece of double-sided tape. In some embodiments, the circuit can be printed on to a substrate that itself may be adhesive on both sides. In some embodiments, adhesive may be applied (such as by spray) to both sides of a printed circuit. FIG. 11 is a schematic diagram showing such a sensing circuit 1101 with two adhesive surfaces. In FIG. 11, the sensing circuit 1101 has breaks along resealable seams 1102a and 1102b, and can embedded, for example, within a material that is rolled into a cylinder, where the circumference of the cylinder is equal to the length 1104. The sticky printed circuit can be, for example, embedded between two layers of material. In some embodiments, the sensing circuit is not visible from the exterior surface of the security device, is not visible from the interior surface of the security device, or not visible from either the internal or external surface of the security device.

One non-limiting example for using sensing circuit 1100 is to embed the sensing circuit 1101 within two layers of paper, and use the paper to encircle and wrap stacked currency bills. Because the sensing circuit 1101 is hidden from view, the person unwrapping the currency bills (e.g., a bank teller or a customer) may not know of the presence of the sensing circuit 1101 within the wrap. However, if the bills are stolen (e.g., in a bank robbery) of tampered with, the opening of the sensing circuit 1101 will alert the authorized user.

Any of the sensing circuits described herein may be printed on a flexible material. Flexible materials are well known in the art. For example, the flexible material may simply be a thin dielectric film. The flexible material may include, for example, sodium acetate. In further non-limiting examples, the flexible material may include polyethylene terephthalate (PET), polyethylene-naphthalate (PEN), or polyimide (PI), or any combination of such materials (e.g., the flexible material may comprise sodium acetate and PEN).

It should be noted that for all of the sensing circuits described herein that are adherable to a surface, the sensing circuit can be adhered to an exterior surface or an interior surface of a container to make a security device. For example, if the sensing circuit is adhered to the internal surface of a container, when the container is closed, the circuit may not be visible. In some embodiments, the sensing circuit is not visible when the container is open. For example, a sensing circuit can be disposed in an inner layer of a three or more layer sheet. For example, a three layer sheet can be folded into an envelope, with at least one resealable seam positioned across the opening flap of the envelope. The owner or controller of the circuit embedded in the envelope can be alerted to its opening, but the person opening the envelope may not know that the act of unsealing the envelope has sent a signal to a designated computing device. In this manner, the owner or authorized user of the envelope and/or the valuable objects in the envelope can know of who has access to them, without revealing that he or she has this information to the opener of the envelope.

Referring to a sensing circuit that is printed and has a resealable seam, although an authorized user may likely open a security device 100 having a sensing circuit adhered to it or embedded in it along the one or more resealable seams (see, e.g., resealable seam 302 in FIG. 3), other users (e.g., an unauthorized user) may attempt to open the security device 100 in different manners. For example, a user may attempt to dismantle the security device 100 by tearing its body open. When the user punctures the security device 100 (e.g., within one of the square surfaces of sensing circuit 201, by way of example), the user breaks the sensing circuit 201 and thereby leaves it open. Consequently, the opened sensing circuit 201 notifies the designated computing device 150 of the access. Because the sensing circuit 201 covers much of the surfaces of the security device 100, opening the security device 100 in many locations opens the sensing circuit 201. In this manner, the sensing circuit 201 provides security along many potential points of access for the security device 100.

In some embodiments, the sensing circuit 101 (see FIG. 1) stores a credential for authorized access, and the transceiver 108 is configured to receive, as well as transmit, signals over one or more wireless communication networks. As used here, by “credential” is meant data indicating that a user is an authorized individual or entity (e.g., a password or user identifier). As the term is used herein, by “authorized user” is simply someone (e.g., a human) who is authorized to open the circuit. Note that the opening of the sensing circuit by the authorized user can still cause a signal to be sent by the opened sensing circuit.

In some embodiments, to obtain authorized access to the contents of security device 100 (contents of which may include a desirable object), a user can be required to provide a credential to the sensing circuit 101. For example, the user may store a credential in the application 165 on the designated computing device 150, and the application 165 may send a signal to the sensing circuit 101 of the security device 100 via a transceiver (in lieu of the receiver 155). In some embodiments, the designated computing device 150 sends the signal using near field communication (NFC). The processor 107 receives the signal and compares the credential in the signal with the credential stored in the sensing circuit 101. If the credentials match, the processor 107 recognizes that the user is authorized to access the contents of the security device 100. When the user opens the sensing circuit 101 along the resealable seam 102, and the processor 107 notifies the designated computing device 150 that an authorized access has been made. However, if the user opens the sensing circuit 101 elsewhere, the processor 107 indicates that the access was unauthorized, even if the user had provided the appropriate credential.

However, if the processor 107 does not receive a matching credential, either because the processor 107 does not receive any credentials at all or receives a credential that fails to match the one stored in the sensing circuit 101, the processor 107 recognizes that the user is not authorized. Any subsequent opening of the sensing circuit 101 is reported to the designated computing device 150 as an unauthorized access. The designated computing device 150 stores information about each access to the security device 100 contents. For example, a wireless communication signal from the sensing circuit 101 may include the time of an access and whether or not the access was authorized. In this manner, the designated computing device 150 provides a user with a history of authorized and unauthorized accesses to the security device 100, for review.

In some embodiments, the sensing circuit 101 can have adhesive on the side the circuit is not printed onto. In other words, the sensing circuit 101 may include an adhesive backing that is either part of the material the sensing circuit is printed onto, or is attached to the material after the sensing circuit is printed onto that material. Any number of adhesives may be applied to the back of material (e.g., either before or after the sensing circuit 101 is printed onto it), including fluoropolymer-, acrylic-, and epoxy-based adhesives. As a result, when the sensing circuit 101 is adhered to a container to form a security device 100, the sensing circuit 101 may cover each surface of the security device 100 with the printed electronics to provide security at every point of access to the security device 100.

Once a user has provided a credential to the security device 100, the user may have a predetermined period of time to open the security device 100 along the resealable seam. If the user waits until this period of time elapses, the sensing circuit 101 may deem the access to be unauthorized. Thus, the designated computing device 150 may be notified of an unauthorized access, instead of an authorized one. Furthermore, the sensing circuit 101 may be configured to send an additional signal when the sensing circuit 101 is closed at the resealable seam 102. Because these signals confirm to the designated computing device 150 that the security device 100 has been closed, by reviewing the records on the designated computing device 150, the user may become aware that the security device 100 remains open and its contents are vulnerable to unauthorized access.

Although the sensing circuit 101 has been described with respect to a single credential, in some embodiments, the credential may be shared among multiple individuals authorized to access the security device 100. Each individual may store the credential on his or her computing device, and when a user wishes to access the contents of the security device 100, his or her computing device may transmit the credential to the sensing circuit 101. In some embodiments, when the sensing circuit 101 opens along the resealable seam, the sensing circuit 101 merely transmits the time of access to the designated computing device 150. A user's computing device may also transmit an identifier of the user along with the credential, and the sensing circuit 101 of the security device 100 may include the identifier in its signal to the designated computing device 150. Alternatively, each authorized user may have a unique credential, and the sensing circuit 101 may store credentials for all of the authorized users. When the sensing circuit 101 receives a signal with a credential, the sensing circuit 101 may determine if the credential is among its stored credentials, and further transmit the identity of the received credential and/or user to the designated computing device 150.

In some embodiments, users with credentials for accessing the contents of security devices 100 may have computing devices similar to the designated computing device 150, i.e., devices with processors 160 that execute applications 165 related to the security system described herein. However, in some embodiments, the users may use any device with the capacity to transmit the credential. For example, a user's device may store the credential as a file, and the user may use any of the communication functions of the device to transmit the credential to a security device 100. The user may select the file for the credential, and then activate near field communication (NFC) to send it. Alternatively, the user may select the file for transfer via Bluetooth.

In another aspect, the present disclosure provides a security device that is connected to the internet of things via a circuit covering or incorporated into at least a portion of the interior or exterior surface of the security device, where the device further comprises additional components including, without limitation, a photo camera, a video camera, a global positioning system, a geo-locator, a locking mechanism, a thermometer, and a hygrometer.

### Exemplary Use Cases

### Example 1: Restricting Access to Medical Marijuana

A 35-year old male patient suffers from rheumatoid arthritis, and his doctor has prescribed edible medical marijuana for his condition. However, the patient has a 10-year-old child, and out of concern that the child may eat the marijuana, he does not want the child to have access to the drug. Furthermore, the patient wants to be notified immediately if the child nevertheless gains access the marijuana.

He purchases a security device as described herein (e.g., as depicted in FIGS. 5A-5D) and downloads an application for the security device onto his smartphone. When he visits the edible marijuana dispensary to have his prescription filled, he obtains a credential based on his prescription. He enters an identifier for the purchased security device and the credential into the application. When he places his smartphone near the device, the smartphone communicates with the device via near field communication (NFC) to load the credential into the circuit of the security device, thereby linking the security device with the application on his smartphone. (Alternatively, he purchases the device through the dispensary, and the device comes pre-loaded or pre-programmed with a credential. The dispensary then associates his prescription with his credential in his smartphone).

Note that to maintain the edible marijuana in a consumable condition, the security device used in this Example 1 may be outfitted with a temperature and humidity sensor.

To access the edible marijuana in his security device, he opens the application on his smartphone and instructs the application to send the credential to the device. When the 3-D circuit on the device receives the credential, its processor compares the credential to the one stored in its circuit. If the credentials match, the circuit in the security device waits for a predetermined period of time for the circuit to open at the resealable seam (i.e., at the security device's opening). If the circuit is opened along this resealable seam within the period of time, the processor communicates with the application over a wireless network to indicate that an authorized access to the contents of the container was made at a particular time. In this manner, the application on the patient's smartphone may receive and store data regarding the container's history of authorized accesses, which the patient may review at his convenience. Once the patient retrieves a dose of edible marijuana, the patent replaces the marijuana in the security device and closes the security device at the resealable seam.

After the predetermined period of time elapses, the patient is no longer authorized to access the contents of the security device. The patient must provide the credential again. If the patient does not and still opens the security device, the processor can send a signal indicating an unauthorized access. Moreover, if the patient opens the security device at any location other than the resealable seam, whether or not the patient has properly provided the credential, the processor can register an unauthorized access.

Because the child does not have access to the credential, if the child attempts to puncture or cut open the box, the circuit opens and sends a signal to the patient's designated computing device that an unauthorized access has been made. In this manner, the patient will immediately receive a notification regarding the unauthorized activity. Furthermore, if the child manages to obtain the patient's computing device and use the credential to open the security device, the patient will recognize a stored record for an access that he did not make, and become aware of the unauthorized access.

### Example 2: Restricting Access to Absentee Ballots

Many states allow their residents to vote in elections via absentee ballots. Residents may complete absentee ballots and mail them to the government agencies overseeing the election. Because the number of absentee ballots may be sizable, their votes may have significant influence in an election. Thus, maintaining their integrity is an important part of the electoral process, and restricting access to the absentee ballots until they are ready to be tallied by the appropriate election personnel may be an important objective. Additionally, knowing the physical location of the absentee ballot may also be important.

An election office may purchase security devices, such as the devices described herein, and divide the absentee ballots among the security devices for storage. Furthermore, the office may designate a select number of personnel to have authorized access to the security devices and the absentee ballots within. The election office may assign each authorized personnel a unique credential, and supply each security device with the credentials of personnel who may access its contents. In some embodiments, all authorized personnel may access any security device, whereas in other embodiments, some personnel may access some security devices, but not others. Each authorized person may load his or her respective credential into an application on a smartphone. The application may be associated with the circuit secure storage system, or the application may be any application configured to transmit a signal with a credential using near field communication (NFC).

The election office designates an administrator to receive notifications regarding accesses to the security devices. As a result, the administrator's smartphone is the only computing device that receives notifications. Each time an authorized personnel provides a credential to a security device that he or she is allowed to access, and opens the security device along the resealable seam, the container sends a signal over a wireless network to the administrator's smartphone regarding the event. The smartphone may store a record of the access, including the date and time, identity of the container, and identity of the authorized personnel.

Personnel may attempt to open a security device whose contents he or she does not have permission to access. Although a person may supply a credential, the person still may have authorization for that particular security device. Should the person open the security device, at the resealable seam or otherwise, the security device will send a signal about the unauthorized access to the administrator's smartphone, thereby creating a record regarding someone's potential attempt to tamper with absentee ballots. If a person with no credentials at all tries to open a container, the security device will likely send a signal about the unauthorized access, but the smartphone will notify the administrator that a person, likely from outside the election office, has compromised the contents of a particular security device.

1. A printed circuit for a security device, the printed circuit comprising:
a sensing element comprising a conductive trace disposed on a substrate, the substrate having a resealable seam crossing a point along the conductive trace, wherein the conductive trace is configured to be connected and disconnected at the point when the resealable seam is opened and closed, respectively; and
an electronics module operably coupled to the sensing element, the electronics module configured to provide a current source for the sensing element, the electronics module comprising a processor and a communications circuit, wherein:
the processor is configured to detect the disconnecting of the conductive trace by measuring a characteristic of the sensing element; and
the communications circuit is configured to transmit a signal over a wireless communication network to a designated computing device when the processor detects the disconnecting of the conductive trace.

2. The printed circuit of claim 1, wherein the substrate is a flexible material.

3. The printed circuit of claim 1, wherein the substrate is a flexible adhesive backing, the adhesive backing adherable to a container such that a portion of a surface of the container is covered with the conductive trace when the adhesive backing is adhered to the container.

4. The printed circuit of claim 1, wherein the substrate is a surface of a container and wherein the conductive trace is printed onto the surface of the container.

5. The printed circuit of claim 4, wherein the container is adapted to contain at least one desirable object.

6. The printed circuit of claim 1, wherein the electronics module of the circuit is configured to store a credential for authorized access into the security container.

7. The printed circuit of claim 6, wherein the communication circuit is configured to send a signal indicating an authorized access when the processor (i) receives a signal with a credential that matches a credential stored in the electronics module and (ii) detects the resealable seam is opened and the conductive trace is disconnected.

8. The printed circuit of claim 7, wherein the electronics module is configured to receive the signal with the credential via near field communication (NFC).

9. The printed circuit of claim 6, wherein the communication circuit is configured to send a signal indicating an unauthorized access when the processor detects the resealable seam opening without receipt of a signal with a credential that matches a credential stored in the electronics module.

10. The printed circuit of claim 1, wherein the substrate is sodium acetate.

11. The printed circuit of claim 1, further comprising, coupled to the processor, at least one of a temperature sensor, a humidity sensor, a geolocation sensor, and a camera.

12. A security device comprising:
a container having a surface with an opening;
a sensing element coupled to the opening, the sensing element including a conductive trace configured to be opened and closed when the opening of the surface is opened and closed; and
an electronics module coupled to the sensing element, the electronics module configured to provide a current source for the sensing element, the electronics module comprising a first processor and first communications circuit, the first communications circuit configured to send a signal over a wireless communication network to a designated computing device when the conductive trace is open.

13-16. (canceled)

17. The security device of claim 12, wherein the container is a cylindrical container including a cylindrical body and at least one lid, the body having an interior surface and an exterior surface, the lid shaped to cover a first end of the cylindrical body.

18. The security device of claim 17, wherein the conductive trace is distributed over a first portion of the interior surface of the cylindrical body.

19. The security device of claim 12, wherein the security device comprises a first compartment positioned near the first end configured to house a desirable object and a second compartment configured to house the electronics module.

20. The security device of claim 12, further comprising a panel positioned between the first and second compartments, wherein an electrical connection between the conductive trace and the electronics module crosses from the first compartment to the second compartment.

21-25. (canceled)

26. A security system for protecting a desirable object, the security system comprising:
a security device comprising:
a container having a surface with an opening;
a sensing element coupled to the opening, the sensing element including a conductive trace configured to be opened and closed when the opening of the surface is opened and closed; and
an electronics module coupled to the sensing element, the electronics module configured to provide a current source for the sensing element, the electronics module comprising a first processor and a first communication circuit, the first communication circuit configured to send a signal over a wireless communication network to a designated computing device when the first processor detects that the conductive trace has opened; and
the designated computing device comprising a second communication circuit for receiving the signal over the wireless communication network and a second processor configured to process the signal received by the second communication circuit.

27-33. (canceled)

34. The security system of claim 26, wherein the container is a cylindrical container including a cylindrical body and at least one lid, the body having an interior surface and an exterior surface, the lid shaped to cover a first end of the cylindrical body.

35. The security system of claim 34, wherein the conductive trace is distributed over a first portion of the interior surface of the cylindrical body.

36. The security system of claim 34, wherein the second processor is configured to process the signal to determine if the lid of the security device has been removed.

37. The security system of claim 26, wherein the security device comprises a first compartment positioned near the first end configured to house a desirable object and a second compartment configured to house the electronics module.

38. The security system of claim 37, further comprising a panel positioned between the first and second compartments, wherein an electrical connection between the conductive trace and the electronics module crosses from the first compartment to the second compartment.

39-43. (canceled)
